(19) United States
(12) Patent Application Publication
(10) Pub. No.: US 2006/0034569 A1
(43) Pub. Date: Feb. 16, 2006

(54) Novel folded Mach-Zehnder interferometers and optical sensor arrays

(75) Inventors: Min-Yi Shih, Niskayuna, NY (US); Christopher James Kapusta, Duanesburg, NY (US); Todd Ryan Tolliver, Clifton Park, NY (US); Renato Guida, Wynantskill, NY (US); Samhita Dasgupta, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/917,847

(22) Filed: Aug. 11, 2004

(51) Int. Cl. G02B 6/26

(52) U.S. Cl. 385/39; 385/12

(57) ABSTRACT

The invention provides novel “folded” Mach-Zehnder interferometers (“folded” MZI's), methods for making folded MZI's, and systems and devices incorporating them. The novel folded MZI's are elaborated from conventional MZI structures by cutting across the interferometer arms of a conventional MZI structure and creating reflectors on the exposed ends of the interferometer arms to form two “folded” MZI's from a single conventional Mach-Zehnder interferometer structure. The novel folded MZI's show promise as sensors having a reduced size and enhanced sensitivity relative to sensors incorporating conventional Mach-Zehnder Interferometers.

### BACKGROUND OF THE INVENTION

The invention relates to optical sensors and systems comprising optical sensors. More particularly, the invention relates to a novel class of Mach-Zehnder interferometers and sensing systems comprising them.

An interferometer is an optical device that splits a light wave into two waves, using a beam splitter or de-coupler, delays the waves by transmission along unequal optical paths, recombines them, and detects a phase-difference in terms of intensity or polarization changes of their superposition. Depending on variations and detail in design and function, interferometers are of many kinds including Mach-Zehnder, Michelson, Sagnac, Fabry-Perot, Murty and the like.

The Mach-Zehnder interferometer in a planar waveguide format is of particular interest due to its narrow-band wavelength capabilities that make it particularly suited for electric field sensing and like applications. A Mach-Zehnder interferometer (referred to hereinafter as an “MZI”) in a planar waveguide format is a device having an optical input, at least two interferometer arms (i.e. waveguides), an optical output and at least two optical couplings, said couplings being capable of working as optical power splitters, one optical coupling being positioned between the optical input and the interferometer arms, and another optical coupling being positioned between the interferometer arms and the optical output. Conventional Mach-Zehnder interferometers are well known in the art and are described in detail in “Elements of Photonics” by Keigo lizuka, Wiley-Interscience; 1st edition (May 15, 2002) which is incorporated by reference herein in its entirety.

MZI's are particularly attractive in applications such as telecommunications and sensors. MZI's allow, for example, variation of the optical power splitting ratio of the MZI outputs based upon a difference in optical path lengths of the two interferometer arms. A difference in optical path length between the two arms can be deliberately induced, for example by means of a suitable control and stimulation, to obtain a variable attenuator or an optical switch. This effect can be exploited to detect and measure characteristic properties of materials or structures which, when placed in contact with one of the two interferometer arms, can induce variations in the optical length thereof.

Particularly for analog acoustic detection, the fiber optic sensor of choice is the MZI sensor. In any interferometric sensor, phase modulation is mapped into an intensity modulation through a raised cosine function. Because of this nonlinear transfer function, a sinusoidal phase modulation generates higher order harmonics. An interferometer biased at quadrature (interfering beams π/2 out of phase) has a maximized response at the first order harmonic and a minimized response at the second order harmonic. For this reason, quadrature is the preferred bias point. As the bias point drifts away from quadrature (for example, in response to a temperature change), the response at the first order harmonic decreases and the response at the second order harmonic increases. When the interferometer is biased at 0 or π radians out of phase, the first order harmonic disappears completely. The decreased response at the first order harmonic (resulting from the bias point's movement away from quadrature) is referred to as “signal fading”.

Because MZI sensors have an unstable bias point, they are especially sensitive to the signal attenuation (or drift) just mentioned. In order to overcome signal fading, a demodulation of the returned signal is required. The typical demodulation technique is the Phase-Generated Carrier (PGC) scheme, which requires a path-mismatched MZI sensor. The path imbalance also causes the conversion of laser phase noise into intensity noise which particularly qualifies the performance of an MZI sensor array at low frequencies and places stringent requirements on the linewidth of the source.

For specialty diagnostic applications it is desirable for an MZI-based sensing system to be as small and light-weight as possible, in some embodiments preferably microscopic. A lower power consumption for MZI based sensing systems is also desired. There is a need therefore for MZI's of reduced size and complexity, as well as MZI-based sensing systems of reduced size and complexity. Further there is a need for practical methods of making MZI's which are adapted such that the size of the MZI may be reduced relative to known MZI's.

### SUMMARY OF THE INVENTION

The present invention meets these and other needs by providing folded Mach-Zehnder interferometers, sensing systems comprising at least one folded Mach-Zehnder interferometer, sensor arrays comprising at least one folded Mach-Zehnder interferometer, and methods for making folded Mach-Zehnder interferometers.

Thus, in one aspect the present invention provides a folded Mach-Zehnder interferometer comprising a y-splitter, a pair of interferometer arms terminated by reflective mirrors, and a waveguide adapted to transmit both incoming signals and outgoing signals in opposite directions.

In another aspect the present invention provides a sensing system comprising: (a) a light source providing a light input beam, the light source being optically connected to at least one waveguide having a length; (b) at least one sensor optically connected to the waveguide; (c) at least one detector receiving a light output beam, the detector being optically connected to the waveguide; wherein the light input beam and the light output beam travel a portion of the length of the waveguide in opposite directions.

In another aspect the present invention provides a sensor array comprising a plurality of folded Mach-Zehnder interferometers.

In another aspect the present invention provides an optical network comprising a sensor array which comprises a plurality of folded Mach-Zehnder interferometers.

In yet another aspect the present invention provides methods for making “folded” Mach-Zehnder interferometers (“folded” MZI's).

These and other aspects, advantages, and salient features of the present invention will become apparent from the following detailed description, the accompanying drawings, and the appended claims.

### BRIEF DESCRIPTION OF THE DRAWINGS

FIG. 1 is a representation of a conventional Mach-Zehnder interferometer in a planar format.

FIG. 2 is a representation of “folded” Mach-Zehnder interferometer according to the present invention.

FIG. 3 is a representation of a sensor network according to the present invention.

FIG. 4 is a representation of a sensing system according to the present invention.

FIG. 5 is a representation of a conventional Mach-Zehnder structure on a silicon wafer substrate.

FIG. 6 is a representation of a conventional Mach-Zehnder structure on a silicon wafer substrate further comprising sensing electrodes.

FIG. 7 is a representation of a conventional Mach-Zehnder structure on a silicon wafer substrate further comprising sensing electrodes and an etched saw path location.

FIG. 8 is a representation of a conventional Mach-Zehnder structure on a silicon wafer substrate further comprising sensing electrodes, an etched saw path location, and saw path.

FIG. 9 is a representation of a folded Mach-Zehnder structure on a silicon wafer substrate prior to metallization of the exposed inteferometer arms surfaces.

FIG. 10 is a representation of a folded Mach-Zehnder structure on a silicon wafer substrate after metallization of the exposed vertical and horizontal surfaces.

FIG. 11 is a representation of a folded Mach-Zehnder interferometer on a silicon wafer substrate comprising a single reflective metallized surface which serves as a mirror.

FIG. 12 is a representation of a folded Mach-Zehnder interferometer on a silicon wafer substrate, said folded Mach-Zehnder interferometer being comprised within an optical network.

### DETAILED DESCRIPTION OF THE INVENTION

In the following description, like reference characters designate like or corresponding parts throughout the several views shown in the figures. It is also understood that terms such as “top,” “bottom,” “outward,” “inward,” and the like are words of convenience and are not to be construed as limiting terms. The term “folded” is a term of convenience and refers to the relationship between the novel Mach-Zehnder interferometers (MZI's) of the present invention and known MZI's. While complete details of “folded” MZI's are provided in the instant disclosure, the idea expressed by the term “folded” MZI is particularly well suited to depiction by example. Thus, if a known MZI possesses a plane of symmetry bisecting the input side from the output side, a “folded” MZI will look like the input side or the output side alone. Conceptually, the MZI is “folded” about the plane of symmetry producing a “folded” MZI design.

As is well known in the art, a sensor is a device capable of detecting and responding to environmental stimuli such as movement, light, heat, the presence of a chemical or biological agent, electromagnetic fields, and the like. A sensor typically converts an input environmental stimulus into another useful form. Optical sensors exploit a variety of different effects for conversion of the input signal. Quantities such as the intensity, phase, frequency or polarization of an optical signal can be modulated by a wide range of environmental stimuli. Most optical sensors comprise an interferometer as a key constituent.

An interferometer is an optical device that splits a light beam into two beams using a beam splitter or de-coupler, delays the two beams by passage along unequal optical paths, recombines the light beams, and detects the phase-difference in terms of intensity or polarization changes of the superposition of the two light beams after their recombination. Depending on variations and detail in design and function, interferometers of many kinds are known including Mach-Zehnder, Michelson, Sagnac, Fabry-Perot, Murty and the like interferometers.

The Mach-Zehnder interferometer is of particular interest due to its narrow-band wavelength capabilities that make it particularly suited for electric field sensing and similar capabilities. Mach-Zehnder interferometer-based devices (i.e. a device comprising at east one Mach-Zehnder interferometer) find applications in sensing systems, antenna sensor arrays, network configurations of sensing system arrays, and other applications as may be known to one skilled in the art.

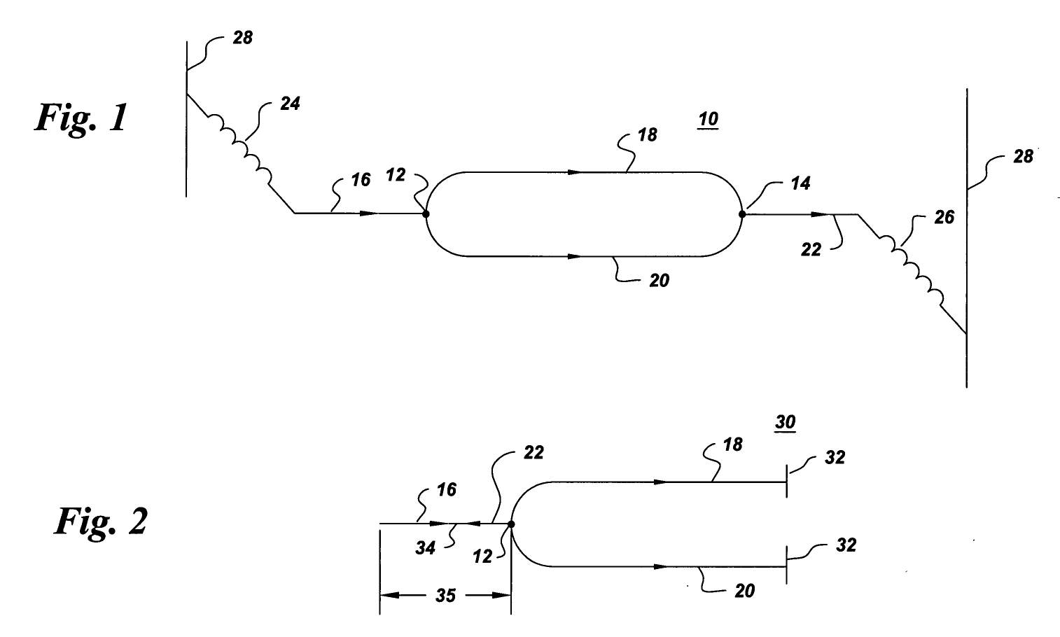

FIG. 1 illustrates a known Mach-Zehnder Interferometer possessing a pair of interferometer arms 18 and 20. Each of the interferometer arms has an optical length equal to βL, where β is the propagation constant of the propagating mode and L is the physical length of the arm. The propagation constant β is in turn equal to (2π/λ)*n, where λ is the wavelength of the propagating mode and n is the refractive index of the propagating mode.

Typically, each optical power splitter 12 and 14 (FIG. 1, also referred to as a “y-splitter” and an “optical connection”) splits the input beam into two nominally equal beams. More generally, however, the optical splitting ratios of the two optical power splitters can be the same or different.

MZI's are devices widely used in many applications in optics, because of their structural simplicity and because they are formed using components that are readily incorporated into optical guides, such as integrated waveguides or optical fibers.

In one aspect, the present invention features “folded” MZI-based sensors adapted for optical multiplexing. Optical multiplexing including time division multiplexing (TDM), wavelength division multiplexing (WDM), code division multiplexing and other means are widely used in the creation of distributed optical networks. In the present invention, “multiplexing” is defined as the combination of multiple signals or channels for transmission of input on a shared medium such as an optical waveguide or an optical fiber. The signals are combined at the input transmitter by a multiplexer and split up at the receiver by a demultiplexer.

Time division multiplexing (TDM) is a method of combining multiple data streams into a single input stream by separating the signal into many segments, each having a very short yet defined duration. Each individual data stream is reassembled at the output end based on the timing. The circuit that combines signals at the source (transmitting) end of a communications link is known as a multiplexer. Typically, the multiplexer accepts input signals from each of a plurality of signal sources, breaks each individual input signal into segments, and assigns the segments to a composite signal in a rotating, repeating sequence. The composite signal transmitted thus contains data from multiple signal sources. The composite signal is then transmitted along an optical guide of some type. At the output end of the optical guide (e.g. a long-distance cable) the data from each individual signal source are separated by means of a circuit called a demultiplexer, and routed to the proper destination. A two-way communications circuit requires a multiplexer-demultiplexer at each end of the long-distance, high-bandwidth cable. If many signals must be sent along a single long-distance line, careful engineering is required to insure that the system will perform properly. An asset of TDM is its flexibility. The TDM strategy allows for variation in the number of signals being sent along the line, and constantly adjusts the time intervals to make optimum use of the available bandwidth. The Internet is an exemplifies a communications network in which the volume of traffic can change drastically from hour to hour. In some systems, a different scheme, known as wavelength division multiplexing (WDM), is preferred wherein the deriving of two or more channels from a transmission medium occurs by assigning a separate portion of the available frequency (or wavelength) spectrum to each of the individual channels. Wavelength division multiplexing (or frequency division multiplexing) is generally popular within the telecommunications industry because it allows them to expand the capacity of their fiber networks without physically altering the transmission fibers. Simply upgrading the multiplexer-demultiplexer at the input and output ends of the signal transmission cable may be all that is required to expand the signal carrying capacity of the cable. Another form of multiplexing, code division multiplexing (or Code Division Multiple Access-CDMA), refers to a technique in which an input transmitter encodes the input signal using a pseudo-random sequence which the output receiver also knows and can use to decode the signal received. Each different random sequence corresponds to a different communication channel. CDMA is extensively used for digital cellular phones and in the transmission of voice messages through telephone and computer networks.

The folded MZI's of the present invention may be are fabricated on a substrate, typically a planar substrate comprising silicon metal, lithium niobate, semiconductor materials, glass, ceramic materials, and plastic materials which may be thermoplastics, or thermosets. In one embodiment the substrate is a silicon wafer. The MZI structure and integrated planar optical guides may be fabricated on the substrate using standard etching, photomasking and photolithography procedures. The MZI device may be interfaced with other components using contact metal pads, in situ cast nanowires, conducting polymers, combinations the foregoing, and the like. In one embodiment an “all-fiber” scheme, the folded MZI's are fabricated directly from optical fibers, properly coupled to each other to form the optical power splitters.

As shown in FIG. 1, a typical Mach-Zehnder interferometer 10, possesses two y-splitters. The first y-splitter 12 equally divides input optical power 16 into two symmetric branches 18 and 20 while the second y-splitter 14 functions as a beam combiner. The y-splitters may also be regarded as optical connections. By modulating the propagation constant (β) of one or both interferometer arms by means of electrical fields, temperature controls, mechanical stresses and other stimuli on one or both branches, a constructive or deconstructive interference of incoming signal takes place at the second y-splitter 14. As a result, the output signal is intensity-, wavelength-, or polarization-modulated. Many alternative types of MZI interferometers including asymmetric interferometers based on the length of the optical paths or the splitting ratio can also be fabricated according to particular design needs.

As shown in FIG. 1, a typical MZI 10 possesses an input 16 and output 22 at each end. Therefore, two optical interconnects 24 and 26 (e.g. two optical fiber “pigtails”) are generally required to integrate a MZI onto the rest of an optical network 28. In particular, for some applications requiring a planar and dense layout, two complicated out-of-plane interconnects are necessary. Since the “pigtails” and optical interconnects are usually complicated to fabricate and often provide unacceptable signal losses, it is desirable to reduce the number of optical interconnects and simplify device fabrication.

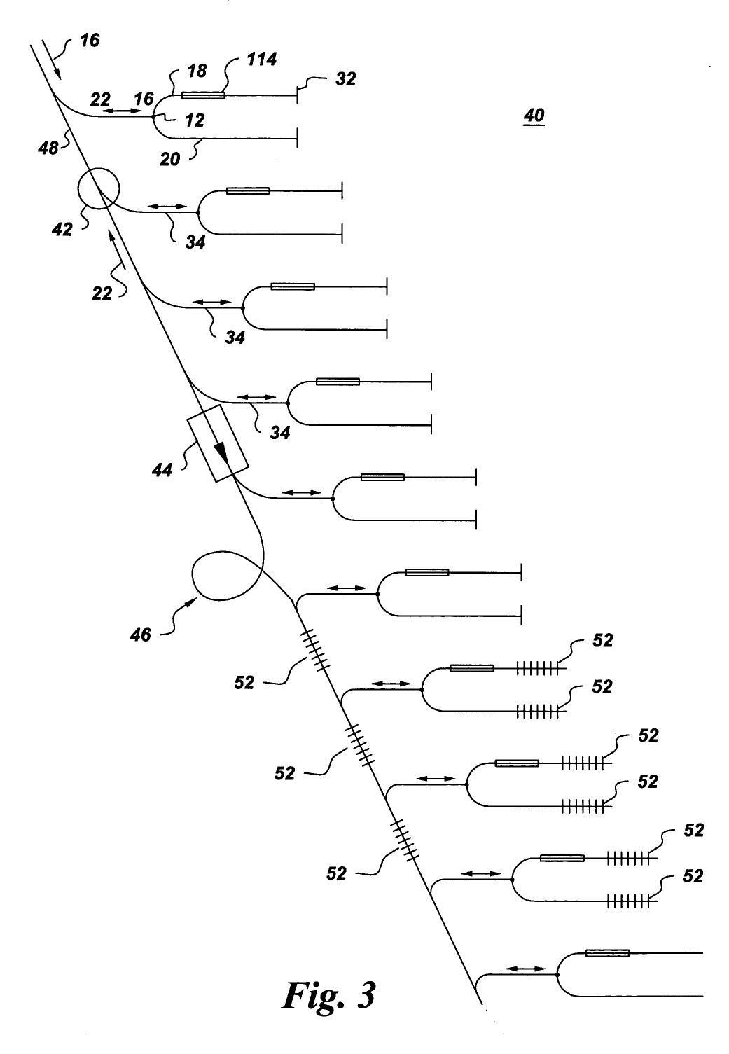

One embodiment of the present invention, shown in FIG. 2, provides a “folded” Mach-Zehnder interferometer 30. A folded MZI 30 comprises only a single y-splitter 12. Optical power is divided into two symmetric branches 18 and 20, is reflected back by reflectors 32 at each branch, and is combined at the same y-splitter 12. In other words, the incoming 16 and outgoing signals 22 share the same waveguide 34. The index (or effective index) modulation can be applied on one or both branches 18 and 20 resulting in signal modulation. The incoming 16 and outgoing signals 22 are usually routed and separated far away from the MZI device. Furthermore, the reflectors 32 can be made using metallic or dielectric materials. The reflectors 32 may comprise any light reflective structures or devices, for example Bragg gratings, to create reflective ends. A folded MZI design consequently, yields a device that requires less physical space, oftentimes one-half as much space is occupied by the folded MZI without any loss in performance relative to a conventional MZI. In addition, the number of optical interconnects required in a folded MZI is typically one half the number of optical interconnects present in a conventional MZI. Most significantly, the sensitivity of the folded MZI device is doubled as a result of its folded configuration, thus making it particularly suited for sensor array applications such as that shown in FIG. 3. It should be noted that the light input beam 16 employed may be a pulsed light signal or a continuous wave signal.

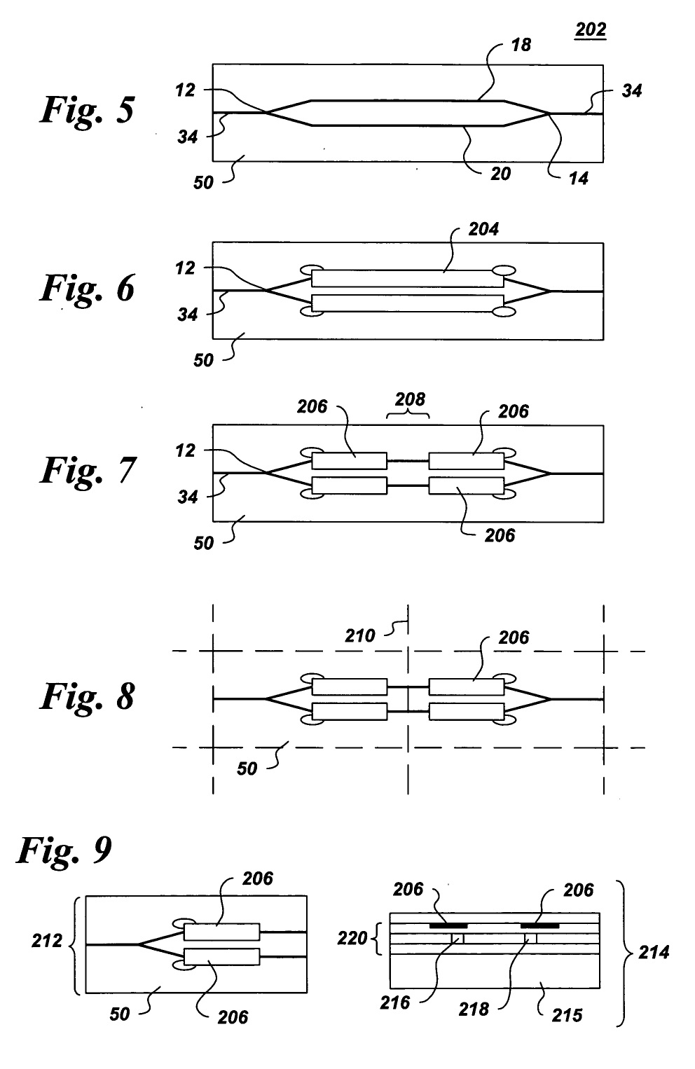

A sensor array 40, shown in FIG. 3, comprises a plurality of folded MZI-comprising sensors. To connect individual sensors and thus provide an entire sensor network, devices such as directional couplers 42 (including asymmetric directional couplers), optical amplifiers 44, optical isolators (not shown), wave-plates (not shown), and delay lines 46 can be incorporated advantageously. For instance, delay lines 46 can be included if the time division multiplexing (TDM) scheme is employed to increase the data bandwidth of the network. Furthermore, each of the individual folded MZI devices can either be connected by optical fibers 48 or waveguides 34, or can be all fabricated or integrated on a single or separated substrate(s) 50 (See FIG. 5). FIG. 3 also illustrates a network incorporating Bragg gratings 52 capable of wavelength division multiplexing (WDM) as a component of the sensor network. Bragg gratings may be used as wavelength-selective mirrors and wavelength add/drop filters. Signal sampling (either “in time” or by wavelength) can be used to distinguish any given signal arising from a particular individual sensor from the other sensors comprising the entire sensor network.

Alternate designs for folded MZI's and sensor arrays comprising folded MZI's are also possible. In one embodiment, the folded MZI comprises asymmetric branches that can be used for optimizing the performance of the device to meet any specific application. In another embodiment, reflective Bragg gratings are used to replace the reflective metallic or dielectric mirrors. In yet another embodiment the entire device is constructed using active gain media (i.e. lasing materials). By applying an additional Bragg grating at the input-output path along with the reflective mirrors or gratings at the ends, a laser cavity may be formed. As a result, the device becomes a fiber-laser or waveguide-laser type of device incorporated within a MZI possessing capabilities for sensing and/or switching. Such a device provides a significant gain enhancement of the incoming signal and potentially increases the sensitivity, dynamic range, and bandwidth of the device. Such MZI sensors can also be fabricated on hybrid “flex/rigid” substrates to suit particular applications.

The MZI sensors of the present invention may be operated in both single-mode and multimode operational modes. A multimode MZI sensor can be considered to act as an optical correlator. In a multimode MZI sensor the output signal modulation is no longer limited by intensity, wavelength, or polarization as described previously; instead, the interference pattern (or Speckle pattern) from the inter- or intra-mode interferences can also be used to sense almost any external modulation from electrical fields, temperature controls, mechanical stresses, and other sources. The dynamic range of such a multimode MZI sensor is greatly increased due to inter- and intra-mode interferences.

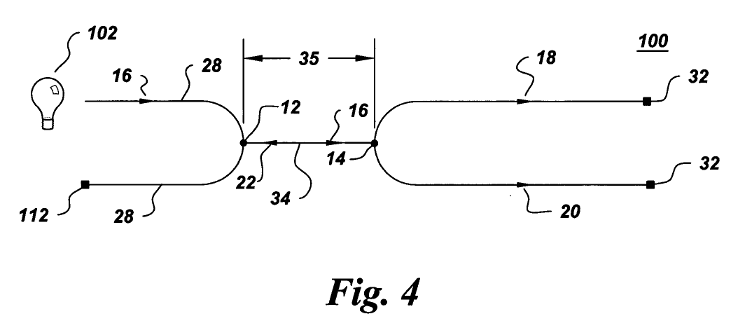

In the present invention and referring to the drawings in general, it will be understood that the figures illustrate different embodiments of the invention, and are not intended to limit the invention thereto. Turning to FIG. 4, the invention provides a sensor system 100 comprising a light source 102 providing a light input beam 16, the light source 102 being optically connected via a first y splitter 12 to at least one waveguide 34 having a length 35; at least one sensor comprising interferometer arms 18 and 20 optically connected via a second y splitter 14 to the waveguide 34; at least one detector 112 for receiving a light output beam 22, the detector 112 being optically connected via y splitter 12 to the waveguide 34. The sensing system 100 may be incorporated into an optical network 28 comprising a plurality of folded MZI-based sensors. The individual components of the sensing system (e.g. the light source 102, waveguide 34, sensor comprising interferometer arms 18 and 20, and at least one detector 112) are optically connected such that the light input beam 16 and the light output beam 22 travel a portion of the length 35 of the waveguide 34 in opposite directions.

Sensing systems comprising one or more folded MZI devices, for example sensing system 100, are believed to be useful in a variety of applications including x-ray imaging systems, baggage inspection systems, spectroscopic sensing systems, antennae, radio-frequency receivers, photonics communication systems, radar detection systems, security systems, identification systems, medical diagnostic systems, implants for monitoring the state of health of a living organism, archival systems, microelectromechanical devices, mobile communication systems, global positioning systems, navigation systems, portable and wall-pluggable probes, network configuration sensing system arrays, antenna sensor arrays, and combinations thereof.

In one embodiment, sensor comprising interferometer arms 18 and 20 is a folded Mach-Zehnder interferometer 30 (See FIG. 2) in which light input beam 16 is derived from at least one of an electromagnetic signal, a mechanical pulse, a chemical response, a biological response, and combinations thereof. The light input beam 16 and the light output beam 22 may be interfaced with one or more devices components selected from the group consisting of directional couplers, splitters, amplifiers, isolators, delay lines, time division multiplexing systems, wavelength division multiplexing systems, code division multiplexing systems, polarization multiplexing systems, optical mirrors, Bragg gratings, and combinations thereof. In one embodiment, the sensing system 100 (FIG. 4) is patterned on a single wafer or on separated multiple platform substrates. The sensing system may be interfaced to an optical network using optical fiber interconnects.

In certain embodiments a delay line 46 (FIG. 3), a signal amplifier 44 (FIG. 3) or a directional coupler 42 (FIG. 3) may be individually and collectively used to increase the optical path length, to amplify an input or output signal, to split an input or output signal, and achieve combinations of these effects. In additional embodiments, sensing system 100 (FIG. 4) also comprises a sensing electrode 114 as shown in FIG. 3.

In one aspect, the present invention provides a method for fabricating “folded” MZI's. The method comprises (a) providing at least one substrate (b) forming a Mach-Zehnder structure on the substrate, wherein the Mach-Zehnder structure comprises at least one waveguide (c) cutting the Mach-Zehnder structure to expose surfaces of the interferometer arms (d) forming a metallic layer on the exposed surfaces of the interferometer arms to provide a folded Mach-Zehnder structure. The folded Mach Zehnder structure so prepared may be incorporated into various optical networks comprising one or more folded MZI-based sensors.

The substrate may comprise a variety of materials including glasses, thermoplastics and thermosets. In one embodiment, the substrate is selected from the group consisting of polyetherimides, polyimides, polyesters, liquid crystalline polymers, polycarbonates, polyacrylates, olefin polymers, and combinations thereof.

In one embodiment, the Mach-Zehnder structure is formed by at least one of lithography, photolithography, photomasking, photopatterning, micropatterning, sputtering, chemical etching, ion-implantation, or a combination thereof. In another embodiment, the formed Mach-Zehnder structure is cut using a diamond saw along a predetermined cutting axis. Other means of cutting the Mach-Zehnder structure include the use of a laser beam, ion etching, and like techniques. Cutting means such as diamond saws, laser beams, and ion etching devices are known to those skilled in the art. In yet another embodiment, the metallic layer is formed using at least one of sputtering, evaporation, physical vapor deposition, chemical vapor deposition, or a combination thereof and comprises at least one of gold, silver, nickel, titanium, titanium-tungsten, copper, aluminum, platinum, silica, tantalum, tantalum nitride, chromium, or a combination thereof. In one embodiment, the folded Mach-Zehnder interferometer is patterned on a single wafer.

The following examples are included to illustrate the various features and advantages of the present invention, and are not intended to limit the invention.

### EXAMPLE 1

### Fabrication of a Folded Mach-Zehnder Interferometer

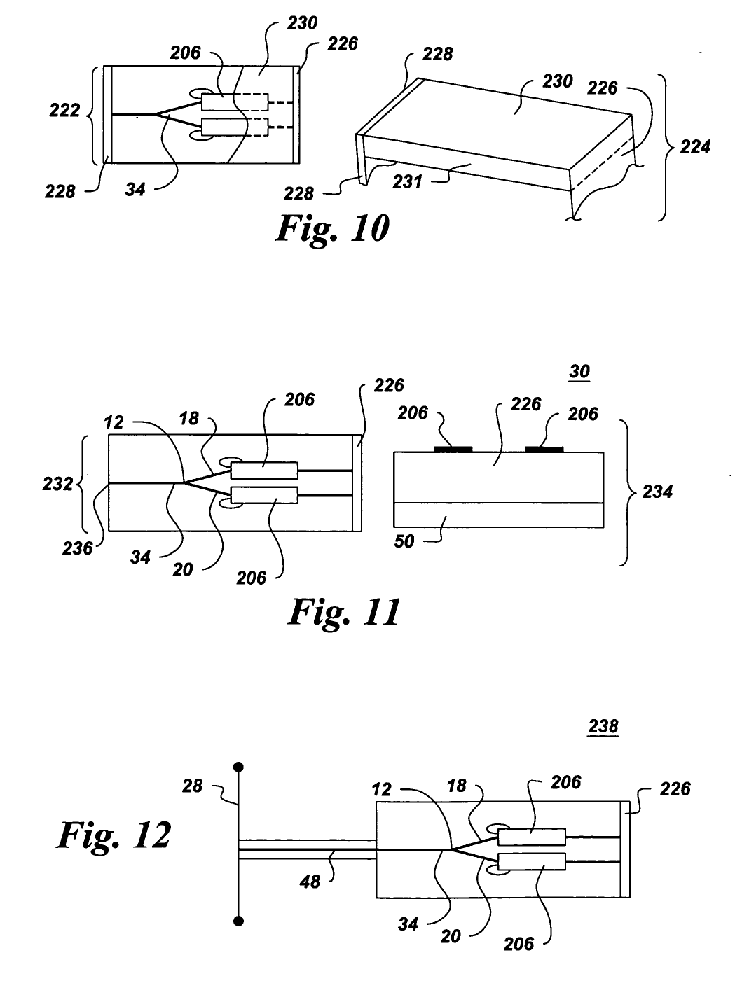

A folded Mach-Zehnder interferometer was fabricated in accordance with the following procedure. As illustrated in FIG. 5 a Mach-Zehnder structure 202 was formed on the top surface of a silicon wafer substrate 50 using conventional processing means to produce a stacked waveguide structure. Cladding layers 220 present in the stacked waveguide structure (present but not shown in FIG. 5) are shown in FIG. 9. Electrodes 204 (FIG. 6) were formed for poling the Mach-Zehnder device by sputtering a layer of gold onto the Mach-Zehnder structure 202 (FIG. 5). A photo-pattern establishing the shape and size of the electrodes was formed on the gold layer and a saw path location 208 (FIG. 7) was etched in the electrode area of the wafer using standard lithography techniques. Thus, an AZ1512 photoresist (available from Microchemicals GmbH (Ulm, Germany)) was spin coated over the gold layer and the resulting spin coated assembly was baked at 90° C. for 1 minute. Photo-patterning was done using a mask and an aligner to obtain the required pattern and the specimen was thereafter baked at 110° C. for 1 minute. The photoresist was developed using OCG 809 photoresist developer diluted with deionized water in a 2:1 proportion. The exposed gold-coated sections were etched using a potassium iodide gold etching mixture and the resist was subsequently stripped using AZ351 at a temperature of about 50° C. AZ351 is available commercially from Hoechst. An additional AZ1512 photoresist was then spin coated onto the structure and baked 1 minute at 90° C. to afford the intermediate assembly shown in FIG. 7. A diamond saw was then used to trim extraneous portions of the assembly and to cut the elaborated Mach-Zehnder structure into two parts using the etched saw path 210 as a guide (See FIG. 8). The vertical surface 215 (FIG. 9) produced by cutting the elaborated Mach-Zehnder structure into two parts comprised the exposed surfaces 216 and 218 (FIG. 9) of the two interferometer arms 18 and 20 (FIG. 5). Aluminum metal was then sputtered onto the vertical surface 215 comprising the exposed interferometer arm ends 216 and 218 (FIG. 9) to form an aluminum mirror 226 on the exposed ends of the interferometer arms. The aluminum mirror 226 had a thickness of less than 1000 Å. A hard mask of KAPTON® film 228 (FIG. 10) was used to protect the input side of the device during metallization. The product of this metallization step is shown in FIG. 10 and comprises a top surface layer of aluminum 230 as well as the vertical aluminum mirror 226. The top surface layer of aluminum 230 and the last applied resist 231 were then stripped from the device by removing the protective KAPTON® film and soaking the elaborated part in a standard AZ1512-stripping solution at 50° C. over a period of several minutes. This provided the folded Mach-Zehnder Interferometer (MZI) assembly shown in FIG. 11 comprising the vertical aluminum mirror 226. An optical fiber 48 (FIG. 12) was then attached to the folded MZI assembly at the input side 236 (FIG. 11) and the resultant folded MZI device was integrated into an optical network 28 (FIG. 12). Experimental measurements confirmed the acceptable performance of the folded Mach-Zehnder Interferometer.

While only certain features of the invention have been illustrated and described herein, many modifications and changes will occur to those skilled in the art. It is, therefore, to be understood that the appended claims are intended to cover all such modifications and changes as fall within the spirit of the invention.

What is claimed is:

1. A folded Mach-Zehnder interferometer comprising:
a) a y-splitter;
b) a pair of interferometer arms and, each of said interferometer arms being terminated by a reflector; and
c) a waveguide adapted to transmit both incoming signals and outgoing signals in opposite directions.

2. A folded Mach-Zehnder interferometer according to claim 1 wherein said reflectors are independently a reflective mirror, Bragg grating, or a combination thereof.

3. A folded Mach-Zehnder interferometer according to claim 1 wherein said reflectors are aluminum mirrors.

4. A folded Mach-Zehnder interferometer according to claim 1 wherein said reflectors are Bragg gratings.

5. A folded Mach-Zehnder interferometer according to claim 1 further comprising at least one sensing electrode.

6. A sensing system comprising a folded Mach-Zehnder interferometer, said system comprising:
a) a light source providing a light input beam, said light source being optically connected to at least one waveguide having a length,
b) at least one sensor optically connected to said waveguide, said sensor comprising two interferometer arms and equipped with means for reflecting light; and
c) at least one detector adapted to receive a light output beam, said detector being optically connected to said waveguide;
wherein said light input beam and said light output beam travel a portion of the length of the waveguide in opposite directions.

7. The sensing system according to claim 6 wherein said sensing system is configured to be connected to at least one of an x-ray imaging system, a baggage inspection system, a spectroscopic sensing system, an antenna, a radio-frequency receiver, a photonics communication system, a radar, a security system, an identification system, a medical diagnostic system, an implant, an archival system, a microelectromechanical device, a mobile communication system, a global positioning system, a navigation system, a portable and wall-pluggable probe, a network configuration sensing system array, an antenna sensor array, or a combination thereof.

8. The sensing system according to claim 6 wherein said light input beam is derived from at least one of an electromagnetic signal, a mechanical pulse, a chemical response, a biological response, or a combination thereof.

9. The sensing system according to claim 6 wherein said light input beam and said light output beam are interfaced with at least one of a directional coupler, a splitter, an optical amplifier, an isolator, a delay line, a time division multiplexing system, a wavelength division multiplexing system, a code division multiplexing system, a polarization multiplexing system, an optical mirror, a Bragg grating, or a combination thereof.

10. The sensing system according to claim 6 wherein said sensing system is patterned on a single wafer.

11. A sensor array comprising:
a) a plurality of folded Mach-Zehnder interferometers.

12. A sensor array according to claim 11, said sensor array further comprising at least one sensing electrode, at least one directional coupler, at least one optical amplifier, at least one delay line, or at least one Bragg grating.

13. A sensor array according to claim 11 comprising at least one sensing electrode.

14. An optical network comprising a sensor array, said sensor array comprising a plurality of folded Mach-Zehnder interferometers.

15. An optical network according to claim 14 wherein said sensor array further comprises at least one sensing electrode, at least one directional coupler, at least one optical amplifier, at least one delay line, or at least one Bragg grating.

16. A method for making a folded Mach-Zehnder interferometer, said method comprising:
a) providing at least one substrate;
b) forming a conventional Mach-Zehnder structure on said substrate, said conventional Mach-Zehnder structure comprising two interferometer arms, and waveguides;
c) cutting said Mach-Zehnder structure to expose surfaces of the interferometer arms; and
d) forming a metallic layer on said exposed surfaces of the interferometer arms to provide a metallized folded Mach-Zehnder structure.

17. The method according to claim 16 wherein said substrate comprises at least one material selected from the group consisting of metals, glass, thermoplatics and thermosets.

18. The method according to claim 16 wherein said substrate is selected from the group consisting of polyetherimdes, polyimides, polyesters, liquid crystalline polymers, polycarbonates, polyacrylates, olefin polymers, or a combination thereof.

19. The method according to claim 16 wherein said Mach-Zehnder structure is formed by at least one of lithography, photolithography, photomasking, photopatterning, micropatterning, sputtering, chemical etching, ion-implantation, or a combination thereof.

20. The method according to claim 16 wherein said formed Mach-Zehnder structure is cut along a predetermined cutting axis using means selected from the group consisting of a diamond saw, a laser beam, and a ion etching device.

21. The method according to claim 16 wherein said metallic layer is formed using at least one of sputtering, evaporation, physical vapor deposition, chemical vapor deposition, or a combination thereof.

22. The method according to claim 16 wherein said metallic layer comprises at least one of gold, silver, nickel, titanium, titanium-tungsten, copper, aluminum, platinum, silica, tantalum, tantalum nitride, chromium, or a combination thereof.

23. The method according to claim 16 wherein said conventional Mach-Zehnder interferometer is patterned on a substrate selected from the group consisting of silicon, glass, ceramic materials, and plastics.

24. The method according to claim 16 wherein said conventional Mach-Zehnder interferometer is patterened on a silicon wafer.
